(19) United States
(12) Patent Application Publication
(10) Pub. No.: US 2024/0382964 A1
(43) Pub. Date: Nov. 21, 2024

(54) POLYMER-BASED MICROFLUIDIC SAMPLE PREPARATION CHIP

(71) Applicant: THE TRUSTEES OF COLUMBIA UNIVERSITY IN THE CITY OF NEW YORK, New York, NY (US)

(72) Inventors: Xiangsong FENG, New York, NY (US); Qiao Lin, New York, NY (US); Sandip Kaledhonkar, Maharashtra, IN (US); Ziao Fu, New York, NY (US); Joachim Frank, New York, NY (US)

(73) Assignee: THE TRUSTEES OF COLUMBIA UNIVERSITY IN THE CITY OF NEW YORK, New York, NY (US)

(21) Appl. No.: 18/785,816

(22) Filed: Jul. 26, 2024

Related U.S. Application Data
(63) Continuation of application No. PCT/US23/11732, filed on Jan. 27, 2023.
(60) Provisional application No. 63/303,716, filed on Jan. 27, 2022.
(60) Provisional application No. 63/303,729, filed on Jan. 27, 2022.

(51) Int. Cl. B01L 3/00; B01F 33/302

(52) U.S. Cl. CPC B01L 3/502784; B01F 33/302; B01L 2300/12

(57) ABSTRACT

The present subject matter relates to devices and techniques for preparing a sample. The disclosed device can include a mixer, a reaction channel, and a micro sprayer. The mixer can be configured to mix at least two components and perform a splitting and recombination (SAR) mixing. The micro sprayer can be configured to generate a droplet of the sample. The mixer and the micro sprayer can be coupled through the reaction channel. The reaction channel can be a microcapillary tubing or a yin-yang reaction channel.

### CROSS-REFERENCE TO RELATED APPLICATION

This application is a continuation of International Patent Application No. PCT/US2023/011732, which was filed on Jan. 27, 2023, which claims priority to U.S. Provisional Patent Application No. 63/303,716, which was filed on Jan. 27, 2022, and U.S. Provisional Patent Application No. 63/303,729, which was filed on Jan. 27, 2022, the entire contents of which are incorporated by reference herein.

### GRANT INFORMATION

This invention was made with government support under grant numbers GM029169, GM055440, and GM139453 awarded by the National Institutes of Health. The government has certain rights in the invention.

### BACKGROUND

In time-resolved cryo-electron microscopy (cryo-EM), a biological reaction can be started by mixing two components and then stopped at one or multiple time points by fast-freezing. Biologically relevant fast reactions, on the time scale of tens of milliseconds, can be observed by cryo-EM because the rapid-freezing itself can take a fraction of a millisecond. Imaging snapshots of such fast reactions require mixing, reacting, and depositing the product on the grid in a fast, controlled way.

Certain techniques use a monolithic silicon chip for mixing and reacting that can withstand a ˜10⁶ Pa liquid pressure drop in the chip, mainly in the mixer channel. However, chips can be costly and time-consuming to manufacture, given production including etching and dicing the silicon wafer and bonding it with glass.

Therefore, there is a need for improved devices and techniques for sample preparation, e.g., that can decrease the pressure drop within the chip and provide faster and cheaper manufacture of the chips.

### SUMMARY

The disclosed subject matter provides microfluidic devices for preparing a sample. An example microfluidic device can include a polydimethylsiloxane (PDMS)-based mixer for mixing at least two components, a reaction channel, and a PDMS-based micro sprayer configured to generate a droplet. In non-limiting embodiments, the PDMS-based mixer and the PDMS-based micro sprayer can be configured to be coupled through the reaction channel. In non-limiting embodiments, the PDMS-based mixer can be configured to perform a splitting and recombination (SAR) mixing, and the reaction channel can include a microcapillary tubing or a yin-yang channel.

In certain embodiments, the microfluidic device can further include an inlet, which can be coupled to the mixer. In non-limiting embodiments, the inlet can be coupled to the PDMS-based mixer through a microfilter.

In certain embodiments, the mixer can include a 3D SAR micromixer. The 3D SAR micromixer can be configured to stretch, rotate, and fold a contact interface within which a sample fluid flows. In non-limiting embodiments, the 3D SAR micromixer can be configured to provide over about 90% mixing efficiency under a pre-determined time. In some embodiments, the pre-determined time is less than 1 ms. In non-limiting embodiments, an inside of the mixer is coated with silicon dioxide (SiO₂).

The yin-yang channel has two curvature points. In non-limiting embodiments, the microcapillary tubing can be configured to control a flow rate of a sample and a reaction time.

In certain embodiments, the disclosed microfluidic device can include a gas inlet for providing gas pressure to the micro sprayer. The micro sprayer can be configured to generate the droplet under a pre-determined gas pressure.

In certain embodiments, the PDMS-based micro sprayer can include an inner tubing and an outer tubing. Orifices of the inner tubing and the outer tubing can be aligned on a same plane. In non-limiting embodiments, the PDMS-based micro sprayer can be configured to generate a three-dimensional (3D) cone plume of sprayed droplets.

In certain embodiments, the PDMS-based mixer, the reaction channel, and the PDMS-based micro sprayer can be disposed on a glass slide.

The disclosed subject matter also provides methods for producing a sample. An example method can include mixing at least two components using a three-dimensional (3D) splitting and recombination (SAR) mixer, inducing a reaction between the at least two components in a reaction channel to generate the sample, and generating a droplet of the sample on a substrate using a micro sprayer. In non-limiting embodiments, the reaction channel can include either a microcapillary tubing or a yin-yang channel. In non-limiting embodiments, the substrate can be an electron microscopy grid.

In certain embodiments, the method can further include coating an inside of the mixer with silicon dioxide (SiO₂) using a plasma-enhanced chemical vapor deposition (PECVD).

In certain embodiments, the method can further include adjusting a reaction time of the at least two components by controlling a geometry of the microcapillary tubing or a flow rate of the at least two components in the microcapillary tubing.

In certain embodiments, the method can include filtering the at least two components using a microfilter.

The disclosed subject matter will be further described below.

### BRIEF DESCRIPTION OF THE DRAWINGS

FIG. 1 provides images showing an example micromixer based on the disclosed splitting and recombination techniques in accordance with the disclosed subject matter.

FIG. 2 provides a graph showing an example mixing simulation using the disclosed micromixer in accordance with the disclosed subject matter.

FIGS. 3A-3B provide images and graphs showing the quantification of the mixing efficiency of the disclosed micromixer in accordance with the disclosed subject matter.

FIG. 4 provides a graph showing an example velocity profile of the disclosed micromixer in accordance with the disclosed subject matter.

FIG. 5 provides images showing an example micro sprayer in accordance with the disclosed subject matter.

FIG. 6 provides images showing example sprayings at different gas pressures using the disclosed micro sprayer in accordance with the disclosed subject matter.

FIG. 7 provides images showing an example assemble and/or disassemble chip in accordance with the disclosed subject matter.

FIG. 8 provides an image and a graph showing an example apoferritin prepared by the disclosed system and its validation in accordance with the disclosed subject matter.

FIG. 9 provides an image showing an example cryo-EM map of eRF1 & eRF3 bound to a eukaryotic 80S pre-termination complex obtained by the disclosed microchip assembly in accordance with the disclosed subject matter.

FIG. 10 provides an image showing an example schematic of the mixing-spraying method with the disclosed silicone microfluidic chip in accordance with the disclosed subject matter.

FIGS. 11A-11B provide images showing an example microfluidic platform for time-resolved cryo-electron microscopy in accordance with the disclosed subject matter.

FIGS. 12A-12E provide images showing an example PDMS-based micro sprayer in accordance with the disclosed subject matter.

FIG. 13 provides a graph showing an example percentage of 50S ribosome subunit and 70S ribosome in the silicon microfluidic device and PDMS microfluidic device at ˜60 ms time frame in accordance with the disclosed subject matter.

FIG. 14 provides an image showing an example microfluidic platform for time-resolved cryo-electron microscopy (TRCEM) in accordance with the disclosed subject matter.

FIG. 15 provides an image showing an example yin-yang-shaped reaction channel in accordance with the disclosed subject matter.

FIG. 16 provides a graph showing an example protein adsorption on the disclosed chips with different coating conditions in accordance with the disclosed subject matter.

FIG. 17 provides an image showing an example sprayer in accordance with the disclosed subject matter.

FIGS. 18A-18C provide images showing an example droplet on cryo-EM grids by the disclosed PDMS sprayer in accordance with the disclosed subject matter.

It is to be understood that both the foregoing general description and the following detailed description are exemplary and are intended to provide further explanation of the disclosed subject matter.

### DETAILED DESCRIPTION

The disclosed subject matter provides devices and techniques for preparing a sample. For example, the disclosed subject matter can be used to prepare a sample for time-resolved cryo-electron microscopy (cryo-EM) with vitreous ice with a controllable consistent thickness.

Unless otherwise defined, all technical and scientific terms used herein have the same meaning as commonly understood by one of ordinary skill in the art. In case of conflict, the present document, including definitions, will control.

As used herein, the use of the word “a” or “an” when used in conjunction with the term “comprising” in the claims and/or the specification can mean “one,” but it is also consistent with the meaning of “one or more,” “at least one,” and “one or more than one.” Still further, the terms “having,” “including,” “containing,” and “comprising” are interchangeable, and one of the skills in the art is cognizant that these terms are open-ended terms.

As used herein, the term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, up to 10%, up to 5%, and up to 1% of a given value. Alternatively, e.g., with respect to biological systems or processes, the term can mean within an order of magnitude, within 5-fold, and within 2-fold, of a value.

The terms “comprise(s),” “include(s),” “having,” “has,” “can,” “contain(s),” and variants thereof, as used herein, are intended to be open-ended transitional phrases, terms, or words that do not preclude additional acts or structures. The singular forms “a,” “an,” and “the” include plural references unless the context clearly dictates otherwise. The present disclosure also contemplates other embodiments “comprising,” “consisting of,” and “consisting essentially of,” the embodiments or elements presented herein, whether explicitly set forth or not.

The term “coupled,” as used herein, refers to the connection of a device component to another device component by methods known in the art. For example, each of the disclosed components can be coupled through a wire, a tube, a capillary tube, or other suitable techniques known in the art. The term “coupled,” as used herein, can include direct contact (e.g., mechanical contact) or indirect coupling.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 as well as all intervening decimal values between the aforementioned integers such as, for example, 1.1, 1.2, 1.3, 1.4, 1.5, 1.6, 1.7, 1.8, and 1.9. Ranges disclosed herein, for example, “between about X and about Y” are, unless specified otherwise, inclusive of range limits about X and about Y as well as X and Y. With respect to sub-ranges, “nested sub-ranges” that extend from either endpoint of the range are specifically contemplated. For example, a nested sub-range of an exemplary range of 1 to 50 can include 1 to 10, 1 to 20, 1 to 30, and 1 to 40 in one direction, or 50 to 40, 50 to 30, 50 to 20, and 50 to 10 in the other direction. Ranges disclosed herein, for example, “between about X and about Y” are, unless specified otherwise, inclusive of range limits about X and about Y as well as X and Y.

In certain embodiments, the disclosed subject matter provides a device for preparing a sample. The disclosed device can include a mixer, a tubing, and a sprayer. In non-limiting embodiments, the mixer and the sprayer can be coupled using the tubing.

In certain embodiments, the disclosed device can include a mixer for mixing at least two components. In non-limiting embodiments, the mixer can be configured to perform splitting and recombination (SAR) mixing. For example, the mixer can be a three-dimensional (3D) micromixer, which can stretch, rotate, and fold a contact interface within which a sample/component fluid flows. The SAR mixing technique can split the contact surface between fluids into many surfaces and then recombine the surfaces to enhance the mass transport between two solutions and thus increase the mixing efficiency.

In non-limiting embodiments, the SAR mixer can provide improved mixing efficiency. For example, mixing efficiencies of over 90% can be achieved at flow rates from 3 μL/s to 6 μL/s, at which the mixing times range from 1 ms to 0.4 ms, respectively. In non-limiting embodiments, the mixing time, which is determined by the flow rate, can be less than 1 millisecond (ms). For example, a mixing time of 0.4 ms can be achieved with a flow rate of 6 μL/s.

In certain embodiments, the pre-determined reaction time can be controlled by adjusting the flow rate of the components at the inlets of the mixer. For example, the flow rate of the components at the inlets can range from about 3 μL/s to about 6 μL/s.

In non-limiting embodiments, the disclosed mixer can provide over 90% mixing efficiency when the flow rate of the components in the mixer ranges from about 3 μL/s to about 6 μL/s.

In certain embodiments, the mixer can comprise polydimethylsiloxane (PDMS), IP-S (Nanoscribe), IP-Q Nanoscribe), or AZ photoresist (MicroChemicals). In non-limiting embodiments, the mixer can be coated with silicon dioxide (SiO2) to prevent the samples/components from sticking to the inner wall of the mixer. For example, plasma-enhanced chemical vapor deposition (PECVD) techniques can be used to coat a thin SiO₂ layer on the interior PDMS SAR micromixer walls. In non-limiting embodiments, the resulting deposition can be controlled by altering the plasma conditions, the source gas for the plasma, the vacuum pressure, the substrate temperature, or other parameters. In some embodiments, about 94% of the initial concentration can be sprayed out with the coated device.

In certain embodiments, the disclosed device can include at least one microfilter made of the same PDMS block as the micro mixer. For example, two microfilters can be coupled to the inlets of the mixer and configured to retain unwanted particles in the sample/component solution to avoid blocking the disclosed mixer. For example, the microfilters can filter particles with a diameter larger than about 10 micrometers (μm), about 20 μm, about 30 μm, about 40 μm, or about 50 μm. In non-limiting embodiments, the microfilter can be directly coupled to the mixer or coupled to the mixer through a tubing.

In certain embodiments, the disclosed device can include at least one inlet. For example, the disclosed device can include at least two inlets for introducing the components into the device. In non-limiting embodiments, the inlets can be coupled to the mixer. For example, the device can include more than two inlets that can deliver the sample/component solution to the SAR mixer for mixing. In non-limiting embodiments, the inlets can be coupled to the microfilters, which can be coupled to the mixer. In some embodiments, the diameter of the inlet can range from 200 μm to about 500 μm.

In certain embodiments, the sample/component can include any components that can react with each other. For example, the component can include a protein, a chemical, a microorganism, an organic material, an inorganic material, a solution, a deoxyribonucleic acid (DNA), or a ribonucleic acid (RNA) that can cause any reaction when it is in contact with another component. In non-limiting embodiments, the component can include fluorescent molecules, a buffer solution, a sample protein, a sample RNA, a sample of a ribonucleic protein complex (RNP) such as the ribosome, a sample organism, or combinations thereof.

In certain embodiments, the disclosed device can include a tubing that connects the mixer to the sprayer. For example, the mixer and sprayer can be coupled through a microcapillary tubing. In non-limiting embodiments, the tubing can include PDMS, glass, or polyamide-coated glass. In non-limiting embodiments, the radius of the tubing can range from 75 μm to about 1000 μm.

In certain embodiments, the tubing can be configured to cause a reaction of at least two components. For example, the tubing can include a yin-yang-shaped reaction channel. A challenge in reaching long reaction times can be to fold the reaction channel into a small area on the microfluidic chip. This has been done with meandering channel designs. In contrast to the reaction channels that are meander-shaped and contain multiple points of high curvature, the yin-yang-shaped reaction channel has only two curvature points. This can be an advantage as a sample in the channel can tend to clog at points of high curvature, precluding multiple uses of the chip.

In certain embodiments, the tubing can be configured to control the reaction time of the sample/component solution in the tubing. For example, the reaction time can be controlled by adjusting the volume of the tubing and/or the flow rate of the sample/component solution. The reaction time can range from about 5 ms to about 1000 ms. The flow rate in the tubing can range from about 3 μl/s to about 6 μl/s. In non-limiting embodiments, about 0.2 m long tubing of 150 μm diameter can provide about a 600 ms reaction time.

In certain embodiments, the disclosed device can include a sprayer. The sprayer can be configured to generate a cone of droplets of the sample or the reacted components. For example, the sprayer can be a micro sprayer configured to generate a three-dimensional cone plume of sprayed droplets. In non-limiting embodiments, the sprayer can include an inner tubing serving as a liquid injector and an outer tubing as a gas nozzle. In some embodiments, orifices of inner and outer tubing can be aligned on the same plane to avoid dripping of the solution from the orifice when lower gas pressure is used. For example, the disclosed sprayer can generate droplets without dripping at about 5 psi or higher gas pressures.

In certain embodiments, the disclosed device can include at least one gas inlet for providing gas pressure to the sprayer. The gas inlet can be connected to the sprayer, and the micro sprayer can be configured to generate the droplets under a pre-determined gas pressure. The pre-determined gas pressure can range from about 5 psi to about 50 psi.

In non-limiting embodiments, the device can be a chip assembly. For example, the mixer, the microcapillary tubing, and the sprayer can be assembled on a glass slide. In some embodiments, each component of the microfluidic device (i.e., mixer, filter, tubing, sprayer, and/or a combination thereof) can be reused or replaced after disassembly.

The disclosed subject matter also provides methods for producing a sample. An example method can include mixing at least two components using the disclosed three-dimensional (3D) splitting and recombination (SAR) mixer, inducing a reaction between at least two components in the disclosed microcapillary tubing to generate the sample, and generating droplets of the sample on a substrate using the disclosed micro sprayer. In non-limiting embodiments, the microcapillary tubing can include a yin-yang reaction channel.

In certain embodiments, the sample can be a sample for microscopy analysis. In non-limiting embodiments, the substrate can be an electron microscopy grid.

In certain embodiments, the method can further include coating the inside of the mixer with silicon dioxide (SiO2) using the method of plasma-enhanced chemical vapor deposition (PECVD). In non-limiting embodiments, the coating can mitigate the sample/component adsorption by inner walls. According to clean room protocol, the thickness of the coating is about 1.5 μm.

In certain embodiments, the method can further include adjusting the reaction time of at least two components by controlling the geometry of the microcapillary tubing or the flow rate of the reaction mixture in the microcapillary tubing. In certain embodiments, the method can further include filtering at least two components using the disclosed microfilters at the inlets of the micromixer.

In certain embodiments, the disclosed subject matter provides a polymer-based chip for preparing samples for time-resolved cryo-EM. An example chip assembly can include certain replaceable modules: 1) a PDMS-based SAR micromixer with 3D self-crossing channels, which can efficiently mix the solutions, 2) a tubing (e.g., a polyimide-coated glass capillary tubing), which can ensure precise flow-rate control of liquids, to serve as the reaction channel for defining the reaction time, and 3) a PDMS-based sprayer employed to spray out the droplets of the reaction product onto the EM grid.

In non-limiting embodiments, the chip assembly can be cost-effective and can be rapidly fabricated. By preparing samples that undergo preselected times of reaction as vitreous ice of controllable, highly consistent thickness on cryo-EM grids, the disclosed device can be used for assessing short-lived states in biomolecular interactions.

### EXAMPLES

### Example 1: PDMS-Based Microfluidic Chip Assembly for Sample Preparation in Time-Resolved Cryo-EM, With SAR Micromixer, Microcapillary Reaction Channel and 3D Micro Sprayer

The disclosed subject matter provides a microfluidic chip assembly to prepare samples for time-resolved cryo-EM (TRCEM). In the disclosed microfluidic device, a biological reaction can be started by mixing two components and then stopped at one or multiple time points by fast-freezing for time-resolved cryo-electron microscopy (cryo-EM). Biologically relevant fast reactions, on the time scale of 10 to 1000 of milliseconds, can be observed by cryo-EM because the rapid-freezing itself can take a fraction of a millisecond. Imaging snapshots of such fast reactions can be achieved by mixing, reacting, and depositing the product on the grid in a fast and controlled way.

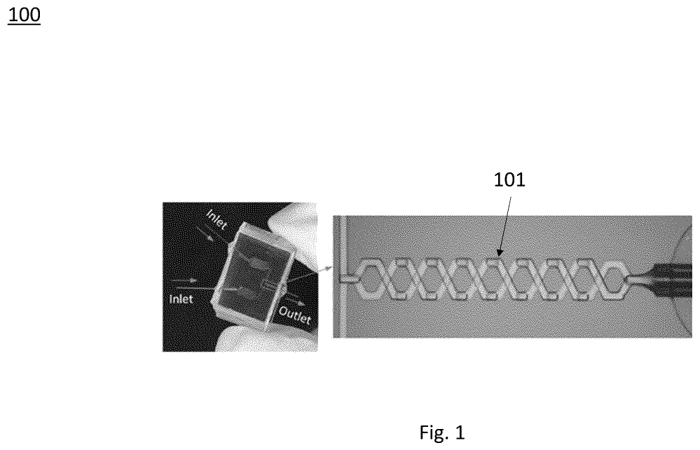

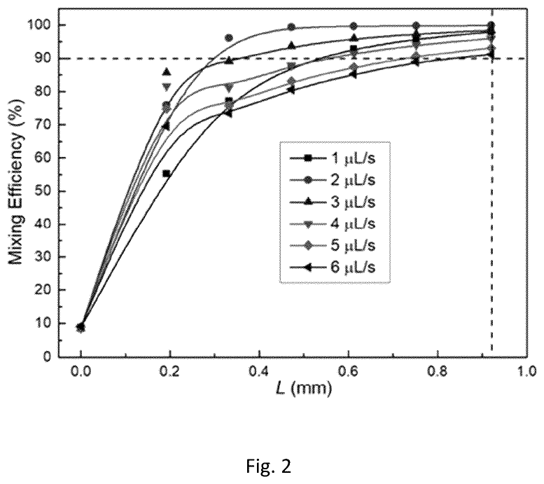

In certain embodiments, the disclosed microfluidic device can include a micromixer. For example, as shown in FIG. 1, the micromixer can be a 3D splitting and recombination (SAR) polydimethylsiloxane (PDMS)-based micromixer (101) with 3D-self-crossing channels. The 3D SAR PDMS-based micromixer (101) can provide improved efficiency than the planar micromixer. FIG. 2 shows mixing simulations for a 3D SAR PDMS-based micromixer. FIG. 2 shows the mixing efficiency along the outflow direction under different total flow rates, where L=0.92 mm represents the position of the outlet. As shown in FIG. 2, if the total flow rate ranges from 3 to 6 μL/s, the mixing efficiency, after passing five mixing units, remains higher than 90%. Such a working range with high efficiency has not been achieved with other micromixers (e.g., the butterfly-type micromixer).

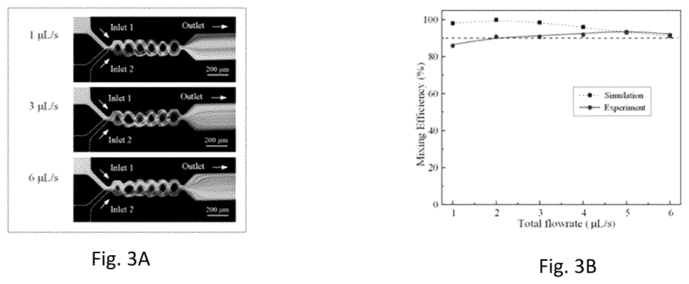

FIGS. 3A-3B show the experimental quantification of the mixing efficiency at the mixer outlet compared to the simulation results. FIG. 3A shows the mixing of target liquids under total flow rates of 1, 3, and 6 μL/s. At a total flow rate of 1 μL/s, the fluorescence intensity is not perfectly distributed at the mixer outlet, indicating inefficient mixing occurred under this condition. When the flow rate increases to 6 μL/s, more striations appear at the mixer outlet because of the strong rotation and splitting of the contact surface between two fluids, indicating that the mixing can be greatly enhanced. As shown in FIGS. 2 and 3B, based on the good agreement between the mixing efficiency of the disclosed mixer (i.e., experimental results) and simulation results, when the total flow rate varies from 3 to 6 μL/s, the mixing efficiency at the outlet exceeds 90%. As flow rates between about 3 μL/s and about 6 μL/s can be used with high efficiency for mixing, a wide range of reaction times can be achieved using a single chip. For example, when a flow rate of 6 μL/s is used, and the volume of the mixer is 280 nL, the mixing time will be around 0.5 ms.

In certain embodiments, the micromixer can include 3D self-crossing channels. In non-limiting embodiments, the micromixer and the 3D self-crossing channels can be coated with a thin SiO₂ layer. For example, plasma-enhanced chemical vapor deposition (PECVD) techniques can be used to coat a thin SiO₂ layer onto the PDMS microchannel walls. As the hydrophobic PDMS surface can adsorb proteins of interest, the coated surface of the disclosed micromixer and 3D self-crossing channels can reduce the amount of non-specific protein adsorption. In non-limiting embodiments, the resulting deposition can be controlled by altering the plasma conditions, the source gas for the plasma, the vacuum pressure, the substrate temperature, or other parameters. In some embodiments, about 94% of the initial concentration can be sprayed out with the coated device.

In certain embodiments, the disclosed microfluidic device can include a capillary tubing. For example, the capillary tubing can be a polyimide-coated glass capillary tubing to serve as the reaction channel for defining the reaction time. In non-limiting embodiments, the microcapillary tubing can be circular in the transverse section. In some embodiments, the microcapillary tubing can be configured to provide the no-slip boundary condition at the walls when the target liquid flows. Consequently, a parabolic velocity profile can develop at the circular inlet of the tube as the fully developed velocity profile (FDVP), which can be expressed in the following equation:

$${V}_{( y , z )} = 2 \overline{V} ( 1 - \frac{{( y - A )}^{2} + {( z - B )}^{2}}{{r}^{2}} ) \qquad ( 1 )$$

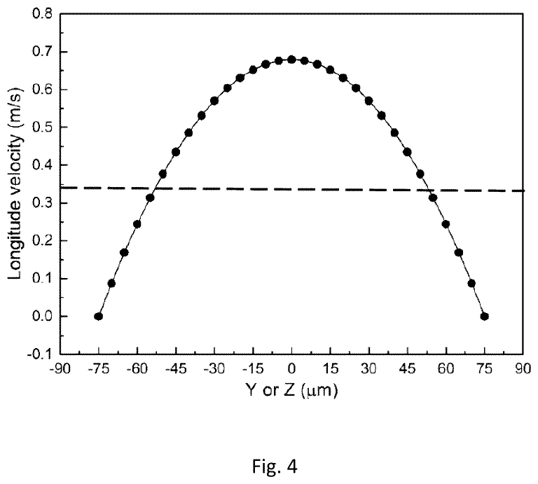

V is the mean velocity, A and B are the coordinates of the center of the inlet, and r is the inner radius of reaction tubing (e.g., r=75 μm). The mean velocity can be determined by the volume of the tubing and the volumetric flow rate. For example, when the flow rate is 6 μL/s, i.e., Re=51, the mean velocity can be about 0.34 m/s, and the maximum velocity can be about 0.68 m/s. As shown in FIG. 4, the fully developed parabolic velocity profile at =0.34 m/s can be set at the inlet.

In non-limiting embodiments, reaction time in the disclosed capillary tubing can be controlled by modifying the volume of the tubing. If the volume of the tubing changes, the mean reaction time (i.e., mean residence time, which is determined by the volume and the mean velocity) can change, so different resolved reaction times can be achieved based on the volume. For example, a 0.2-meter-long tubing with a 150 μm diameter can provide a 600 ms reaction time point. In non-limiting embodiments, an increase in reaction times can be achieved by reducing the flow rate and/or by increasing the volume of the reaction-carrying channel between the mixer and the spray nozzle.

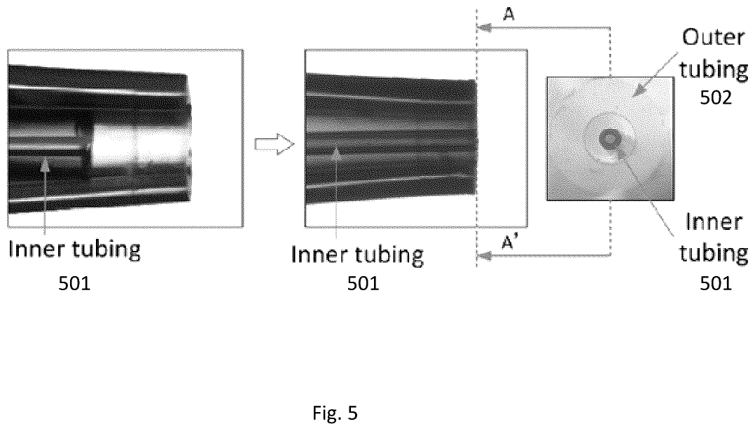

In certain embodiments, the disclosed microfluidic device can include a micro sprayer. For example, the micro sprayer can be a PDMS-based micro sprayer that can spray out the droplets of the reaction product onto the EM grid. The PDMS-based micro sprayer can be used for preparing cryo-EM grids with vitreous ice of controllable, highly consistent thickness. The micro sprayer can be configured to generate a three-dimensional cone plume of sprayed droplets. In non-limiting embodiments, to prevent dripping from the orifice of the micro sprayer at low gas pressure, the orifices of the inner (501) and outer (502) tubings can be aligned on the same plane and also centered precisely, as shown in FIG. 5.

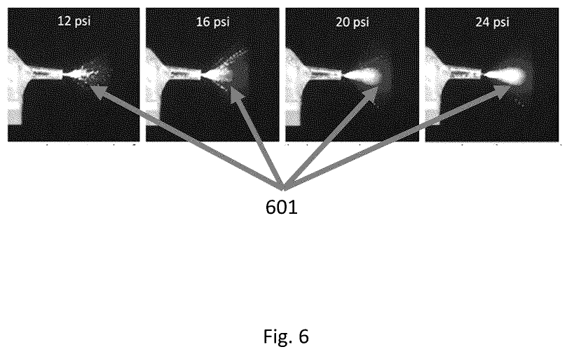

In certain embodiments, the disclosed micro sprayer can provide improved efficiency. For example, the disclosed micro sprayer with the inner and outer tubing orifices aligned on the same plane can provide improved efficiency at low ranges of pressure. For example, FIG. 6 shows that sprayed plumes (601—illuminated by a laser beam) were generated under four gas pressures. Spraying tests are conducted under four different gas pressures to find proper working conditions. PBS buffer solution is injected into the redesigned micro sprayer at a flow rate of 6 μL/s, which is kept constant for all tests. Four different gas pressures (12, 16, 20, and 24 psi) were used to assess the effectiveness of atomization. During the whole spraying process for each gas pressure, no dripping problem can be observed, even at a lower gas pressure of 12 psi. The micro sprayer can provide improved performance even at a lower pressure of 12 psi without dripping, ensuring stable and reproducible spray. This improved performance was also achieved down to gas pressures of 5 psi).

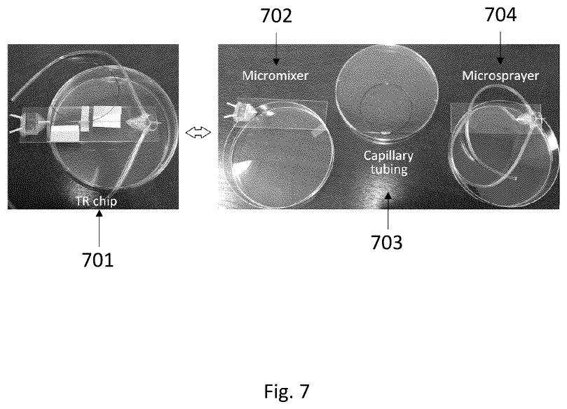

In certain embodiments, the disclosed microfluidic chip can be fabricated through a modular technique. As shown in FIG. 7, the microfluid chip assembly (701) can be customized for preparing grids by assembling it from three modules (e.g., micromixer (702), reaction channel (703), micro sprayer (704)). The reaction channel and micro sprayer can be reused after disassembly, while the micromixer is disposed after each experiment since its performance is degraded with protein adsorption. For example, the disclosed mixer and the sprayer can be connected through the reaction channel. Between the mixer and the capillary reaction tubing, there is a short connecting tubing (length: 3 mm, I.D.: 75 μm, O.D.: 150 μm). Similarly, between the capillary reaction tubing and microsprayer, there is a short connecting tubing (length: 6 mm, I.D.: 75 μm, O.D.: 150 μm). At each joint, a tiny drop of glue is applied for sealing. An advantage of the modular technique can be that any of the three elements of the chip that is found not functioning can be readily replaced by a new one. This can also be convenient for making the channel fresh through oxygen plasma treatment to reduce the protein adsorption before each new reaction experiment.

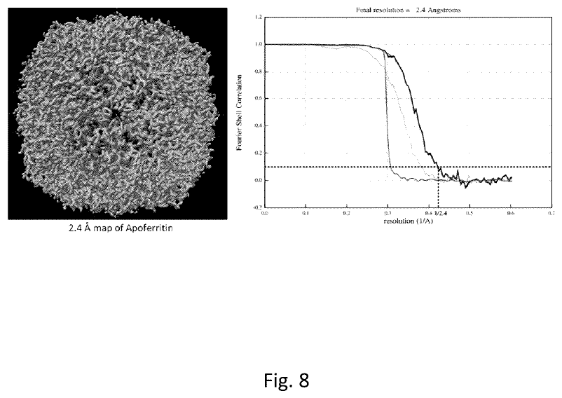

FIG. 8 provides a view of a three-dimensional cryo-EM image of apoferritin at 2.4 Angstrom resolution that can be prepared by the disclosed microfluidic device. Using a 450-ms microfluidic chip, apoferritin (˜8 mg/mL) and PBS buffer were mixed and sprayed on the grid, then the grid was plunged into the cryogen for vitrification.

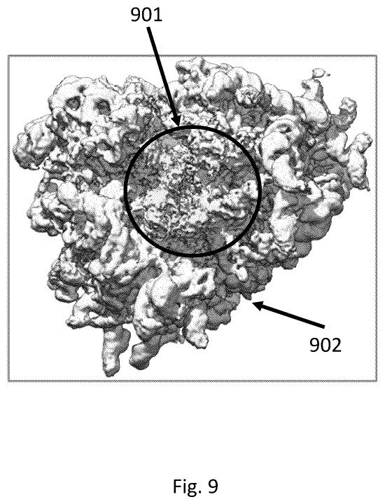

In certain embodiments, the sample prepared by the disclosed microfluidic device can be used to capture intermediate states during protein synthesis. For example, in eukaryotic translation termination, two factors (i.e., eRF1 and eRF3) bind to the pre-termination 80S complex in a short-lived state, which has not been observed previously. As shown in FIG. 9, the disclosed device can be used to image the reaction by using the following conditions: (1) Sample 1—3.5 uM 40S+3.5 uM 60S+8 uM IRES mRNA; (2) Sample 2—10 uM eRF1+10 uM eRF3+1 mM GTP; (3) Reaction time—450 ms; (4) Sample flow rate—6 μL/s; (5) Temperature—˜25° C.; (6) Humidity—˜90%; (7) Gas pressure for the spray—8 to 10 psi; (8) Sprayer-grid distance—5 mm; (9) Plunging height—˜27 mm; (10) EM grids—Quantifoil R 0.6/1 carbon support with 300 Cu mesh; and (11) Plasma cleaning on EM grids—15 mA for 40 s. FIG. 9 shows the 3D cryo-EM map of eRF1 & eRF3 (901) bound to a eukaryotic 80S pre-termination complex (902) obtained by time-resolved cryo-EM using the disclosed microchip assembly. To obtain more complete information about the dynamic process of termination, TR cryo-EM experiments with more time points are used on the mammalian termination process and complement these studies by measuring pre-steady-state kinetics of the GTP and peptidyl-tRNA hydrolysis steps.

In certain embodiments, the disclosed microfluidic device can be a polydimethylsiloxane (PDMS) microfluidic device, which can be rapidly manufactured in a cost-effective way. The disclosed microfluidic device can include the three-dimensional micromixer that is configured to decrease the pressure drop within the microfluidic chip so that the microfluidic device can comprise plastic (e.g., polydimethylsiloxane) for faster and cheaper manufacture of the devices.

Development and testing of SiO2-coated micromixer for mitigating protein adsorption: SiO2 coating was performed inside the PDMS micromixer channel to prevent proteins of the sample from sticking to the PDMS plastic. The measurements show that up to 50% of the protein can be lost without coating. Adverse effects of this problem can include uncontrolled changes in concentration of the two mixing components during the use of the micromixer, rendering the results of time-resolved assessments invalid.

For SiO2 coating, plasma-enhanced chemical vapor deposition (PECVD) was performed to deposit a thin SiO2 layer onto the interior PDMS microchannel walls using the PlasmaPro®NGP80 system (Oxford Instruments, Abingdon, UK). High radio frequency (RF) power (50 W) was used to create plasma inside the process chamber. During plasma treatment, the source gases used for plasma are N2O (710 sccm) and SiH4 (170 sccm), the vacuum pressure is 200 mTorr, the substrate temperature is 300° C., and the coating strike lasts for 20 min. The reaction equation is as below for SiO2 layer formation under plasma conditions,

$$2 {N}_{2} O + {SiH}_{4} = {SiO}_{2} + 2 {N}_{2} + 2 {H}_{2} \qquad ( 2 )$$

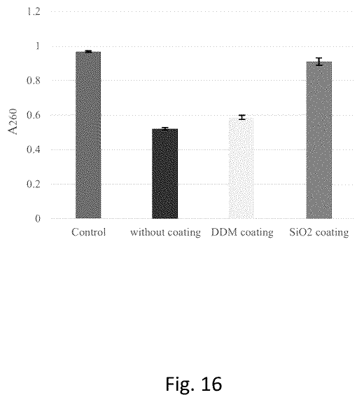

Protein adsorption assessment with E. coli 70S ribosome was performed to compare the chips without coating, with n-dodecyl-β-D-maltoside (DDM) coating, and with SiO₂ coating. DDM is an alkyl polyglucoside, a mild nonionic surfactant that can be used for improving the hydrophicity of the surface of PDMS. The use of ribosomes as a proxy for “proteins” is justified since proteins cover much of the surface of the ribosome. After passing through one of these three kinds of chips with the same sample of 70S ribosomes at least 6 times, the sample was sprayed out and collected for concentration measurement by spectrophotometric analysis using NanoDrop® (Thermo Fisher Scientific, Waltham, MA, USA). The absorbance values at 260 nm (A₂₆₀) for the initial concentration as control is 0.966 on average (where A₂₆₀=1=20 nM). The A₂₆₀ values for the samples using chips with different coating methods are shown in table 2. The measurements of protein concentration after passing the sample through the chips show (FIG. 16) that 94% of the initial concentration is retained using the SiO₂-coated chip, while only 54% and 60% of the initial concentration are retained without coating or with DDM coating, respectively, demonstrating that the SiO₂ coating can effectively mitigate the problem of protein adsorption.

TABLE 2
Absorbance values at 260 nm for the samples using
chips with different coating techniques.

| | | without | DDM | SiO₂ |
|---|---|---|---|---|
| | Control | coating | coating | coating |
| | Absorbance at 260 nm (A₂₆₀) | | | |
| Sample 1 | 0.969 | 0.516 | 0.600 | 0.875 |
| Sample 2 | 0.965 | 0.522 | 0.567 | 0.924 |
| Sample 3 | 0.964 | 0.527 | 0.579 | 0.913 |
| Sample 4 | | 0.510 | 0.605 | 0.928 |
| Sample 5 | | 0.512 | 0.569 | 0.937 |
| Sample 6 | | 0.519 | 0.584 | 0.925 |
| Sample 7 | | | | 0.903 |
| Sample 8 | | | | 0.847 |
| Averaged Absorbance | 0.966 | 0.518 | 0.584 | 0.907 |
| at 260 nm | | | | |
| Standard Deviation | 0.002 | 0.006 | 0.014 | 0.029 |

### Example 2: PDMS-Based Microfluidic Chip Assembly for Sample Preparation in Time-Resolved Cryo-EM, With SAR Micromixer, Yi-Yang Reaction Channel and 3D Micro Sprayer

Certain conventional sample preparation for single-particle cryo-EM involves applying ˜3 μl of liquid containing biomolecules onto a 3 mm diameter support grid, followed by removing extra liquid by blotting, resulting in a thin layer of the liquid. Upon rapid plunging of the grid into a cryogen at a temperature below −160° C., the liquid is transformed into vitreous ice. This blotting method of cryo-EM grid preparation takes at least several seconds and is therefore not suited to capture short-lived states occurring in a reaction. In certain methods of time-resolved cryo-EM, two reactants are rapidly (e.g., ˜0.5 ms) mixed, then allowed to react (e.g., 10-1000 ms). The reaction product is then sprayed onto a dry EM grid as it passes the spray nozzle on its way into the cryogen. The device developed is based on a monolithic silicon chip.

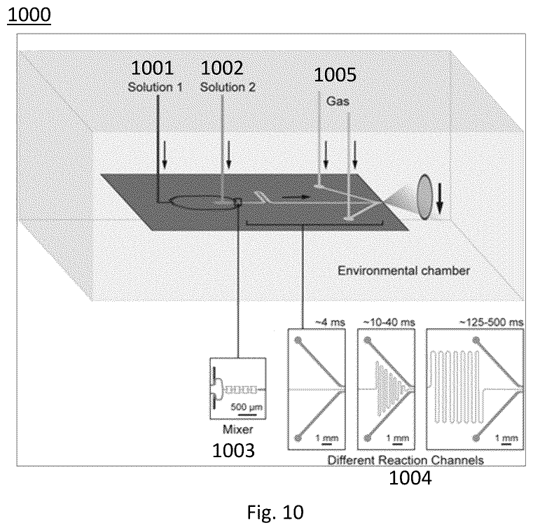

FIG. 10 shows a schematic of the mixing-spraying device (1000) with the silicone microfluidic chip. The chip can include a mixer (1003), where the two reactants of biomolecules (1001) and (1002) are mixed. The chip can also include a reaction channel (1004) that can allow the reactants to react for a defined time. The product of the reaction is sprayed onto the EM grid through a sprayer. The pressure of the sprayer can be controlled by adjusting the gas pressure (1005).

Our chip assembly replaces the silicon-based monolithic microfluidic chip of Lu et al. (2009). Its two advantages are (1) higher efficiency of droplet deposition on the EM grid due to 3D spray cone instead of 2D planar spray geometry; (2) the production of a silicon-based microfluidic device is expensive and lengthy, involving outsourcing at a silicon nanoscale facility. Since each time-resolved project can require a specific set of (more than one) experiments with different time points, several devices with different reaction channels are required, so the length of the fabrication process can be the most critical obstacle. Another disadvantage of the existing silicon chip is that the reaction channel, for reaction times equal to or greater than 140 ms, contains multiple inversion points of high curvature, increasing pressure drop inside the reaction channel and potentially reducing the flow rate.

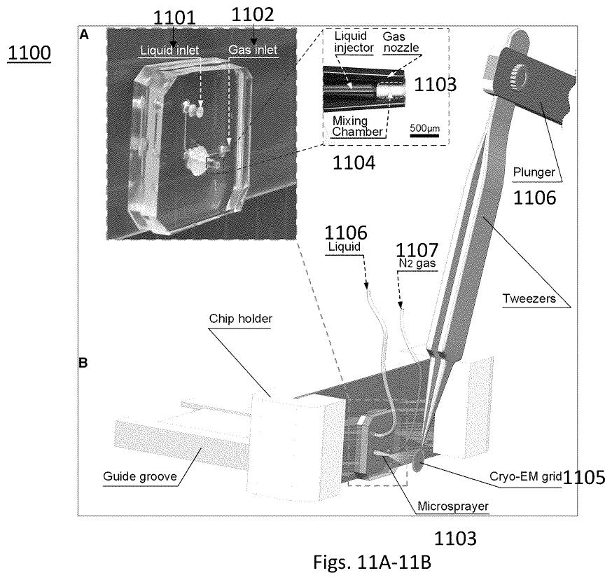

To overcome these challenges, the disclosed subject matter provides a novel Polydimethylsiloxane (PDMS)-based microfluidic device, which is cost-effective and rapid to make. In this PDMS-based microfluidic device mixer, reaction channel, and micro sprayer were all redesigned for better efficiency. As a first development, the micro sprayer was redesigned as a 3D sprayer to spray in a cone, which effectively produces better coverage with droplets on the EM grid. It was first tested on a separate chip with a single-channel feed (FIG. 11).

FIG. 11 shows the PDMS-based micro sprayer (1101). FIG. 11A shows a chip with liquid inlets (1101), gas inlets (1102), and a 3D micro sprayer (1103). The reactants can be injected through the micromixer inlets (1101). The micromixer inlets are coupled to a mixing channel (1104), where the reactants can be mixed and reacted. The pressure inside the 3D micro sprayer (1103) can be adjusted by controlling the pressure of gas that is injected through the gas inlet (1102). FIG. 11B shows the operation of the micro sprayer, where a liquid (1106) and N₂ gas (1107) are injected into the device, and the EM grid (1105), which is mounted on a plunger (1106), passes the spray cone on its way into the cryogen. The micro sprayer has a utility on its own (i.e., for operation without time resolution) for rapid deposition of samples on the EM grid without the need for blotting.

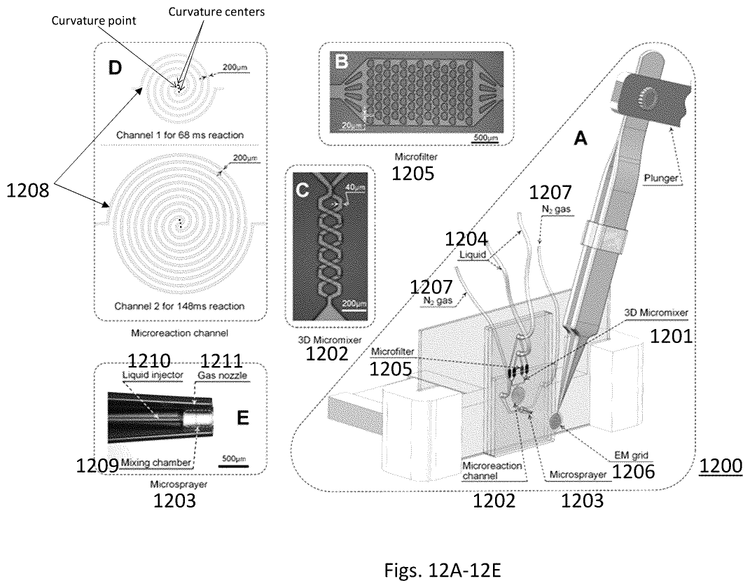

FIG. 12 shows a microfluidic platform for time-resolved cryo-electron microscopy. FIG. 12A shows an overview of the platform. The platform can include a 3D micromixer (1201), a micro reaction channel (1202), and a micro sprayer (1203). The micromixer contains two inlets. Through each inlet, a liquid (1204) can be filtered by a microfilter (1205) and injected into the device. After the filtration, the two liquids (1204) can be mixed and reacted in the 3D micromixer (1201). The reaction mixture produced in the micromixer passes through a reaction channel of variable volume. The reacted liquid (i.e., the reaction product) can be sprayed onto the EM grid (1206) through the micro sprayer (1203). The pressure of the 3D micro sprayer (1203) can be adjusted by controlling the pressure of N₂ gas (1207) that can be injected through a gas inlet. The whole platform can be situated inside the environmental chamber. FIG. 12B is a microfilter (1205) used to retain unwanted particles (>20 μm) in the solution to avoid blocking the following 3-D micromixer. FIG. 12C shows the 3-D micromixer (1202) with 6 nanoliters in volume employed to fast and effectively mix the solutions. FIG. 12D shows examples of two micro-reaction channels with the novel ‘yin-yang’ design (1208) (in this case, 200 μm in width), which permit 68 ms and 148 ms reactions, respectively. FIG. 12E shows a micro sprayer (1203) used for dispensing the reaction product from the reaction channel (1202) onto the EM-grid (1206). In non-limiting embodiments, the micro sprayer (1203) can include a mixing chamber (1209) for generating the droplets, a liquid injector (1210) that couples the mixing chamber to the reaction channel (1202), and a gas nozzle (1211) for spraying the reaction product.

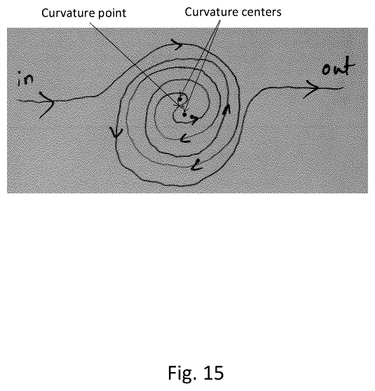

Compared with the silicon-based mixing-spraying device, the disclosed PDMS-based device (FIG. 12) has three main advantages: (1) The mixing of reactants is fast and effective since a three-dimensional micromixer based on the splitting and recombination (SAR) technique is used (FIG. 12C), which is capable of efficiently stretching, rotating and folding the contact interface within which the fluid flows; (2) The novel yin-yang-shaped reaction channel (FIGS. 12D and 15) contains only two single high-curvature points while the channel in the silicon chip (e.g., for time points of 140 ms or greater) contained multiple points of high curvature; and (3) The thickness of the vitreous ice proves to be reproducible, and it can be controlled by tuning the flow rate.

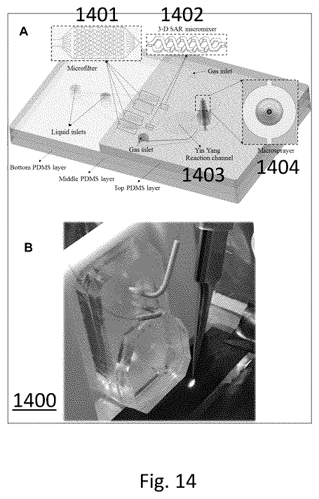

Any pair of solutions, after being filtered by the microfilter (FIG. 12B), can be effectively and uniformly mixed in the 3-D SAR micromixer (FIG. 12C), with mixing efficiency higher than 90% and mixing time of 1 ms when the flow rate is set at 6 μL/s. The mixed fluid flows through the yin-yang channel for a defined time, which can be tuned by varying the channel length (FIG. 12D). After the reaction, the resulting solution is sprayed out by the micro sprayer (FIG. 12 E) onto the EM grid. These four parts, the microfilter (1401), the 3-D SAR micromixer (1402), the yin-yang reaction channel (1403), and the micro sprayer (1404) (FIG. 12B-E and FIG. 15), make up the entire microfluidic device (see FIGS. 14A-14B) (1400). The EM grid covered with a sufficient number of droplets is plunged into the cryogen, resulting in coverage by thin round platelets of vitreous ice of controllable, consistent thickness.

Comparison of the performance of the PDMS device that utilizes the yin-yang reaction channel versus the silicone device: Using the silicon-based microfluidic device, the association reaction of the 70S ribosome by mixing 30S ribosomal and 50S ribosomal subunit at 60 ms and 140 ms were assessed. For 60 ms, 67% of 3D classes were identified as 50S ribosomal subunits, and 33% of 70S ribosomes were observed. For the purpose of comparison, the same reaction at 68 ms time point was observed with the PDMS-based microfluidic device.

Micrographs were collected on the Tecnai F20 TEM at 200 KV with 1.2 Å/pixel with a K2 Summit (Gatan) direct detector camera in counting mode. The Quantifoil R.1/R.2 Cu EM grids were glow-discharged using Gatan Solarus 950 at 25 W for 25 seconds in the presence of H₂ and O₂ gas at a flow rate of 6.4 standard cubic centimeters per minute (sccm) and 27.5 sccm respectively. 30S ribosomal subunits at 2.4 μM and 50S ribosomal subunits at 1.2 μM were injected into the two inlets of the PDMS-based microfluidic device at 3 μL/sec flow rate. Humidified compressed nitrogen gas was passed through N₂ gas inlets of PDMS device at 20 psi pressure to obtain the atomized spray of droplets. For each experiment, the droplets were deposited on a dry glow-discharged Quantafoil EM grid that was being plunged into the cryogen.

From over 900 micrographs collected, 617 good micrographs were selected as assessed by the screening of Thon rings using the program GCTF. About 1,000 particles from these 617 micrographs were manually picked and examined further by 2D classification. From the 2D classes obtained, three templates were chosen to pick the particles from the rest of the micrographs with the RELION auto-picker algorithm. Further, these particles were extracted and subjected to 2D classification using RELION, and 16,000 clean particles were separated (the rest were either ice particles, contained debris, or were noisy).

The 2D classes that had distinctive features of 30S, 50S, and 70S, were selected for 3D classification in RELION. Multiple rounds of 3D classification were used to resolve compositional (50S subunits vs. 70S ribosomes) heterogeneity. A further run of 3D classification was repeated four times to assess the variability of the number of particles per run.

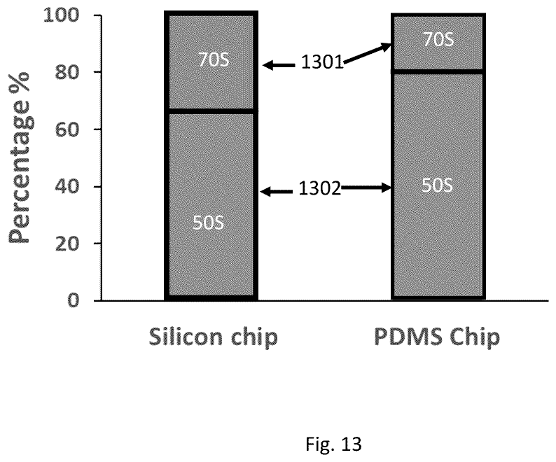

The number of particles of 50S ribosomal subunits and 70S ribosomes in four different 3D classification runs was quite consistent (Table 1). The results showed 79.5% of 50S subunit particles in the 3-D classes and 20.5% of 70S ribosome particles at 68 ms (FIG. 13). FIG. 13 shows the percentage of 50S subunits (1301) and 70S ribosomes (1302) in the silicon microfluidic device and PDMS microfluidic device at ˜60 ms time frame. By comparison, the silicon microfluidic device resulted in 67.0% of the 3-D classes identified as 50S subunits and 33.0% as 70S ribosomes at 60 ms.

TABLE 1
Percentages of 50S ribosomal subunits and 70S ribosomes in each
3-D classification run for the PDMS microfluidic device.

| Ribosome | Run 1 | Run 2 | Run 3 | Run 4 | Std. Dev. | Average |
|---|---|---|---|---|---|---|
| 50S | 77.9% | 77.9% | 79.8% | 82.4% | 1.8 | 79.5% |
| 70S | 22.1% | 22.1% | 20.2% | 17.6% | 1.8 | 20.5% |

The PDMS microfluidic device was found to be a viable alternative to the silicon microfluidic device to capture short-lived reaction intermediates of biomolecular interactions. The preliminary analysis of the association reaction of the 70S ribosome by mixing 30S and 50S ribosomal subunits by the disclosed novel PDMS-based device shows that the percentage of 70S ribosomes is somewhat lower while the percentage of 50S ribosomal subunits is somewhat higher in comparison with the measurements for the silicon device. This indicates that the PDMS device slows down the reaction somewhat in comparison with the silicon device.

Testing of Microfluidic device with yin-yang channel and PDMS-based micro sprayer—assessment of droplets on cryo-EM grids: The disclosed microfluidic chip was used to prepare cryo-EM grids under different spraying conditions with gas pressures (20 PSI, 30 PSI AND 40 PSI) and a constant liquid flowrate of 6 μL/s.

The disclosed PDMS sprayer was used for the assessment of droplet coverage on cryo-EM grids. The disclosed sprayer can have a three-dimensional (3D) design so as to spray the mixed samples in a cone, which effectively produces improved coverage with droplets on the EM grid. By preparing samples that undergo preselected times of reaction and are deposited on cryo-EM grids in droplets with controllable, consistent thickness upon freezing as vitreous ice, the device can provide efficient time-resolved cryo-EM assessments of short-lived states in biomolecular interactions.

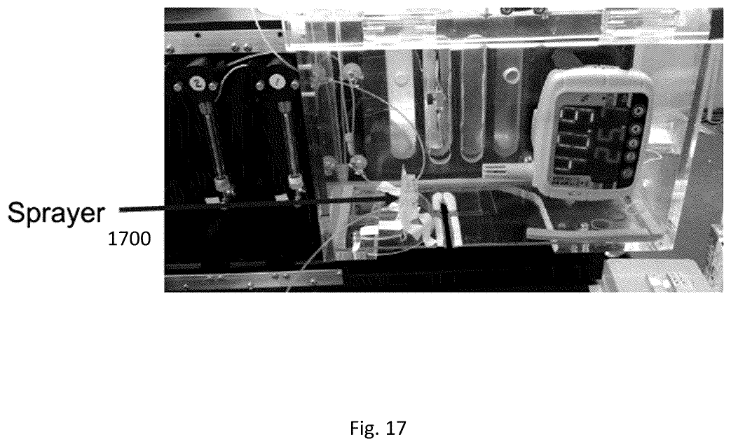

Various conditions were used for the droplet assessment. For example, FIG. 17 shows an example PDMS sprayer platform (1700) with pre-determined conditions (e.g., grids: carbon coated Quantifoil; buffer: 1X HEPES pH 7.4; distance from the sprayer to the grid: ˜1.5 cm; plunging speed: 2 m/s; temperature: 25.7° C.; and humidity: ˜40%). Various pressure levels were used for the droplet assessment.

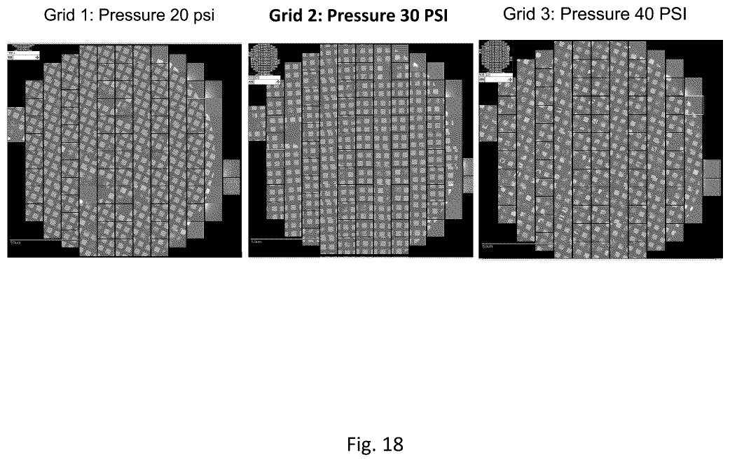

As shown in FIG. 18, higher pressure (e.g., 40 PSI) provided improved coverage and an increased number of droplets. Qualitatively, the size and coverage of the droplets on the grid were better than the coverage of droplets generated by the two-dimensional sprayer built in the silicon chip.

* * *

Unless otherwise defined, all technical and scientific terms used herein have the same meaning as commonly understood by one of ordinary skill in the art. In case of conflict, the present document, including definitions, will control. Certain methods and materials are described below, although methods and materials similar or equivalent to those described herein can be used in the practice or testing of the presently disclosed subject matter. All publications, patent applications, patents, and other references mentioned herein are incorporated by reference in their entirety. The materials, methods, and examples disclosed herein are illustrative only and not intended to be limiting.

While it will become apparent that the subject matter herein described is well calculated to achieve the benefits and advantages set forth above, the presently disclosed subject matter is not to be limited in scope by the specific embodiments described herein. It will be appreciated that the disclosed subject matter is susceptible to modification, variation, and change without departing from the spirit thereof. Those skilled in the art will recognize or be able to ascertain, using no more than routine experimentation, many equivalents to the specific embodiments described herein. Such equivalents are intended to be encompassed by the following claims.

1. A microfluidic device, comprising: a polymer-based mixer for mixing at least two components; wherein the mixer is selected from the group consisting of polydimethylsiloxane (PDMS), IP-S, IP-Q, and AZ photoresist;
a reaction channel;
and a polymer-based micro sprayer configured to generate a droplet,
wherein the polymer-based mixer and the polymer-based micro sprayer are configured to be coupled through the reaction channel, wherein the polymer-based mixer is configured to perform a splitting and recombination (SAR) mixing, and wherein the reaction channel comprises a microcapillary tubing or a yin-yang channel.

2. The microfluidic device of claim 1, further comprising an inlet, wherein the inlet is coupled to the polymer-based mixer.

3. The microfluidic device of claim 2, wherein the inlet is coupled to the polymer-based mixer through a microfilter.

4. The microfluidic device of claim 1, wherein the mixer comprises a 3D SAR micromixer.

5. The microfluidic device of claim 4, wherein the 3D SAR micromixer is configured to stretch, rotate, and fold a contact interface within which a sample fluid flows.

6. The microfluidic device of claim 4, the 3D SAR micromixer is configured to provide over about 90% mixing efficiency under a pre-determined time.

7. The microfluidic device of claim 6, wherein the pre-determined time is less than 1 ms.

8. The microfluidic device of claim 1, wherein an inside of the mixer is coated with silicon dioxide (SiCh).

9. The microfluidic device of claim 1, wherein the yin-yang reaction channel comprises two curvature points.

10. The microfluid device of claim 1, where the microcapillary tubing is configured to control a reaction time.

11. The microfluidic device of claim 1, further comprising a gas inlet for providing gas pressure to the polymer-based micro sprayer.

12. The microfluidic device of claim 11, wherein the polymer-based micro sprayer is configured to generate the droplet under a pre-determined gas pressure.

13. The microfluidic device of claim 1, wherein the polymer-based micro sprayer comprises an inner tubing and an outer tubing, wherein orifices of the inner tubing and the outer tubing are aligned on a same plane.

14. The microfluidic device of claim 1, wherein the polymer-based micro sprayer is configured to generate a three-dimensional (3D) cone plume of sprayed droplets.

15. The microfluidic device of claim 1, wherein the mixer, the reaction channel, and the polymer-based micro sprayer are assembled on a glass slide.

16. A method for producing a sample, comprising mixing at least two components using a three-dimensional (3D) splitting and recombination (SAR) mixer; inducing a reaction between the at least two components in a reaction channel to generate the sample, wherein the reaction channel comprises either a microcapillary tubing or a yin-yang channel; and generating a droplet of the sample on a substrate using a micro sprayer.

17. The method of claim 16, wherein the substrate is an electron microscopy grid. The method of claim 16, further comprising coating an inside of the mixer with silicon dioxide (SiCh) using a plasma-enhanced chemical vapor deposition (PECVD). The method of claim 16, further comprising adjusting a reaction time of at least two components by controlling a geometry of the reaction channel or a flow rate of a reaction mixture of the at least two components in the microcapillary tubing. The method of claim 16, further comprising filtering the at least two components using a microfilter.

18. A microfluidic device, comprising:
a mixer comprising a polymer or glass for mixing at least two components;
a reaction channel; and
a micro sprayer comprising at least one of a polymer, glass, or silicon-based material, configured to generate a droplet,
wherein the mixer and the micro sprayer are configured to be coupled through the reaction channel, wherein the mixer is configured to perform a splitting and recombination (SAR) mixing, and wherein the reaction channel comprises a microcapillary tubing or a yin-yang channel.

19. The microfluidic device of claim 18, further comprising an inlet, wherein the inlet is coupled to the mixer.

20. The microfluidic device of claim 19, wherein the inlet is coupled to the mixer through a microfilter.

21. The microfluidic device of claim 18, wherein the mixer comprises a 3D SAR micromixer.

22. The microfluidic device of claim 21, wherein the 3D SAR micromixer is configured to stretch, rotate, and fold a contact interface within which a sample fluid flows.

23. The microfluidic device of claim 21, wherein the 3D SAR micromixer is configured to provide at least 90% mixing efficiency under a pre-determined time.

24. The microfluidic device of claim 23, wherein the pre-determined time is less than 1 ms.

25. The microfluidic device of claim 18, wherein an inside of the mixer is coated with a hydrophilic material.

26. The microfluidic device of claim 18, wherein the yin-yang reaction channel comprises two curvature points.

27. The microfluidic device of claim 18, wherein the microcapillary tubing is configured to control a reaction time.

28. The microfluidic device of claim 18, further comprising a gas inlet for providing gas pressure to the micro sprayer.

29. The microfluidic device of claim 28, wherein the micro sprayer is configured to generate the droplet under a pre-determined gas pressure.

30. The microfluidic device of claim 18, wherein the micro sprayer comprises an inner tubing and an outer tubing, wherein orifices of the inner tubing and the outer tubing are aligned on a same plane.

31. The microfluidic device of claim 18, wherein the micro sprayer is configured to generate a three-dimensional (3D) cone plume of sprayed droplets.

32. The microfluidic device of claim 18, wherein the mixer, the reaction channel, and the micro sprayer are assembled on a substrate.

33. A microfluidic device for producing a sample, comprising:
a three-dimensional (3D) splitting and recombination (SAR) mixer configured to mix at least two components, wherein the mixer comprises components made in a material selected from the group consisting of a polymer, glass, and silicon-based materials;
a reaction channel coupled to the mixer, wherein the reaction channel comprises either a microcapillary tubing or a yin-yang channel, and is configured to induce a reaction between the at least two components to generate the sample; and
a micro sprayer coupled to the reaction channel and configured to generate a droplet of the sample on a substrate, wherein the micro sprayer comprises components made in a material selected from the group consisting of a polymer, glass, and silicon-based materials.

34. The microfluidic device of claim 33, wherein the substrate is an electron microscopy grid.

35. The microfluidic device of claim 33, wherein an inside surface of the mixer is coated with a hydrophilic material.

36. The microfluidic device of claim 35, wherein the hydrophilic material is silicon dioxide (SiO2) deposited by plasma-enhanced chemical vapor deposition (PECVD).

37. The microfluidic device of claim 33, further comprising a microfilter coupled to an inlet of the mixer, wherein the microfilter is configured to filter the at least two components before they enter the mixer.

38. The microfluidic device of claim 33, wherein the reaction channel is configured to allow adjustment of a reaction time by controlling at least one of: a geometry of the reaction channel and a flow rate of a reaction mixture within the reaction channel.

39. The microfluidic device of claim 33, wherein the micro sprayer is configured to generate a three-dimensional (3D) cone plume of sprayed droplets.

40. The microfluidic device of claim 33, wherein the mixer is configured to provide at least 90% mixing efficiency in less than 1 millisecond.
